(19) United States
(12) Patent Application Publication
(10) Pub. No.: US 2026/0057781 A1
(43) Pub. Date: Feb. 26, 2026

(54) PREWARNING SYSTEM FOR BLIND SPOTS OF FRONT VEHICLE

(71) Applicant: FENG CHIA UNIVERSITY, Taichung City (TW)

(72) Inventors: Yu-Chen LIN, Taichung City (TW); Yong-Hao Zhang, Taichung City (TW); Yu-Ci Zhang, Taichung City (TW); Yu-Ching Yen, Taichung City (TW)

(21) Appl. No.: 18/815,285

(22) Filed: Aug. 26, 2024

(51) Int. Cl. G08G 1/16; G06V 10/44; G06V 10/72; G06V 10/82; G06V 20/58

(52) U.S. Cl. CPC G08G 1/167; G06V 10/44; G06V 10/72; G06V 10/82; G06V 20/58; G06V 2201/08

(57) ABSTRACT

A prewarning system for blind spots of a front vehicle comprises a photographing unit, a computing unit, and a warning unit. A photographing direction of the photographing unit is a traveling direction of a user. The photographing unit captures images of the front of the user to output a real-time image. The computing unit continuously receives the real-time image and executes program data of an image recognition model. The computing unit recognize multiple target features of a target vehicle in the real-time image through the image recognition model. The computing unit predicts a turning path information of the target vehicle according to the multiple target features and computes a range of radius difference between inner wheels according to the turning path information. The computing unit generates a warning signal according to the range of radius difference between inner wheels to control a warning unit, so that the warning unit issues a warning.

### BACKGROUND OF THE INVENTION

### 1. Field of the Invention

The present invention relates to a blind spots prewarning system, especially an assisting system used to warn users of blind spots caused by steering vehicles ahead.

### 2. Description of the Related Art

In order to improve convenience and mobility of life, modern people mainly rely on cars, motorcycles, bicycles as means of transportation, but many traffic accidents also occur. Among them, drivers who ride motorcycles or bicycles with low coverage are more prone to serious casualties than drivers who drive cars in traffic accidents. Main causes of accidents caused by drivers are mostly “failure to pay attentions to situations of vehicles in front”, “speeding”, “drowsy driving”, etc. In recent years, a number of traffic accidents “large vehicles causing motorcycles involvement” has also increased year by year, and most of them are immediate death traffic accidents.

The causes of accidents involving “large vehicles causing motorcycle involvement” are mostly related to sight blind spots and radius difference between inner wheels of the large vehicles. In order to reduce occurrences of accidents, many large vehicles are currently installed with a surround view system. The surround view system allows a driver of a large vehicle to real-time observe situations around the large vehicle through a monitor next to the driver while driving. However, divers of the large vehicles may not have a driving habit of paying attention to the monitor at all times and still rely on their own subjective consciousness to drive the large vehicles. For motorcycle drivers or bicycle drivers driving next to the large vehicles, their personal safety has not been substantially improved. As a result, the number of accidents involving “large vehicles causing motorcycle involvement” has not decreased by installations of the surround view system on the large vehicles.

### SUMMARY OF THE INVENTION

A blind spot caused by radius difference between inner wheels of large vehicles when turning is quite large, and motorcycles, bicycles and even pedestrians often enter the blind spot without being warned, resulting in frequent traffic accidents “large vehicles causing motorcycles involvement”. To overcome the aforementioned issue, the present invention provides a prewarning system for blind spots of a front vehicle comprising:
a photographing unit capturing a front image of a user to output a real-time image, wherein a photographing direction of the photographing unit is a traveling direction of the user;
a computing unit electrically connected with the photographing unit to receive the real-time image; the computing unit executing program data of an image recognition model to recognize a plurality of target features of a target vehicle in the real-time image; the computing unit predicting a turning path information of the target vehicle to compute a range of radius difference between inner wheels and generating a warning signal according to the range of radius difference between inner wheels; and
a warning unit electrically connected with the computing unit to receive the warning signal and outputting a warning according to the warning signal.

The prewarning system for blind spots of a front vehicle of the present invention continuously receives the real-time image captured by the photographing unit through the computing unit. The computing unit performs image recognition for the real-time image to recognize the plurality of target features of the target vehicle in the real-time image. The computing unit predicts a turning path information of the target vehicle according to the plurality of target features and computes the range of radius difference between inner wheels of the target vehicle according to the turning path information. The computing unit generates the warning signal according to the range of radius difference between inner wheels to control the warning unit, so that the warning unit issues the warning to remind the user to pay attention to road conditions ahead and a driving distance. As a result, the prewarning system for blind spots of a front vehicle of the present invention can achieve effects of assisting driving and improving a road safety of the user.

### BRIEF DESCRIPTION OF THE DRAWINGS

FIG. 1 is a circuit block diagram of a prewarning system for blind spots of a front vehicle of the present invention;

FIG. 2 is a circuit block diagram of an embodiment of the prewarning system for blind spots of a front vehicle of the present invention, wherein a computing unit is further connected to a storage unit;

FIG. 3 is a circuit block diagram of an embodiment of the prewarning system for blind spots of a front vehicle of the present invention, wherein the computing unit is further connected to the storage unit and a sensing unit;

FIG. 4 is a diagram of an embodiment of the prewarning system for blind spots of a front vehicle of an embodiment of the present invention, wherein the computing unit computes a distance of a motorcycle and a target vehicle through a real-time image to determine whether the motorcycle will enter a range of radius difference between inner wheels;

FIG. 5 is a circuit block diagram of the prewarning system for blind spots of a front vehicle of the present invention, wherein the computing unit comprises an image pre-processing module, an image recognition module, a path prediction module and an inner-wheels radius difference computing module;

FIGS. 6A to 6C are diagrams of the real-time image after image pre-processing and image recognition by the computing unit, wherein two target features respectively represent a vehicle body center and a vehicle head center;

FIG. 7 is a diagram of the real-time image after image pre-processing and image recognition by the computing unit of the present invention, wherein two target features respectively represent an inner back wheel center and an inner front wheel center;

FIG. 8 is a circuit block diagram in partial section of the prewarning system for blind spots of a front vehicle of the present invention, wherein the Kalman filter is mounted between the image recognition module and the path prediction unit;

FIG. 9A is a diagram of a turning path information of the target vehicle predicted by the path prediction module of the present invention, wherein the diagram includes a body path and a head path of the target vehicle;

FIG. 9B is a diagram of a center of a circle computed by the inner-wheels radius difference computing module according to three body path points in the body path;

FIG. 10 is a diagram of the range of radius difference between inner wheels of the target vehicle computed by the inner-wheels radius difference computing module, wherein the diagram includes an inner front wheel path and an inner back wheel path of the target vehicle;

FIG. 11 is a diagram of the real-time image with the range of radius difference between inner wheels estimated by the present invention.

### DETAILED DESCRIPTION OF THE INVENTION

In order to understand the technical characteristics and practical effects of the prevent invention in detail, and accomplish them according to the content of the present invention, the detailed description is as follows with the embodiments shown in the figures.

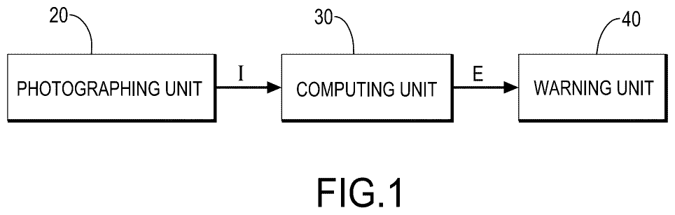

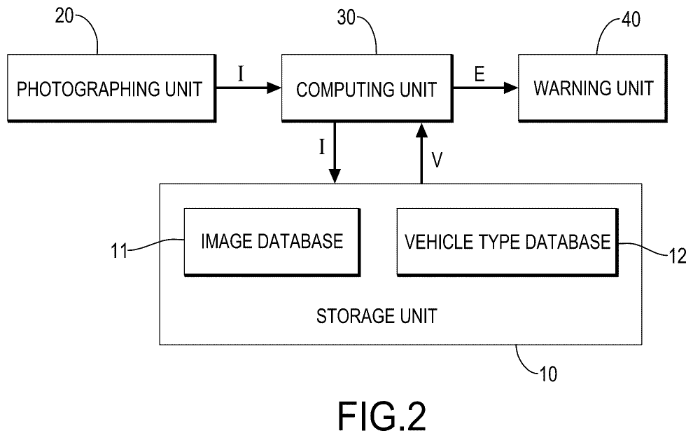

Referring to FIG. 1, a prewarning system for blind spots of a front vehicle of the present invention comprises a photographing unit 20, a computing unit 30, and a warning unit 40. The photographing unit 20, the computing unit 30, and the warning unit 40 can be mounted on a vehicle (hereinafter referred to as a host vehicle, which is behind the foregoing front vehicle) to be vehicle-mounted devices or to be integrated into a wearable device to be equipped on users. The computing device 30 is electrically connected with the photographing unit 20 and the warning unit 40, and the computing device 30 can execute program data of an image recognition model. Referring to FIG. 2, in an embodiment of the present invention, the computing device 30 is further connected with a storage unit 10. The storage unit 10 is not limited to be mounted on the host vehicle or worn on users. For example, the storage unit 10 may be a hard disk, a memory card, etc. mounted on the host vehicle or integrated in the wearable device or a network attached storage (NAS) not mounted on the host vehicle or not integrated in the wearable device. In order to facilitate descriptions of operation methods of the present invention, the following description takes the photographing unit 20, the computing unit 30 and the warning unit 40 as being mounted on a motorcycle as an example.

Before implementing the system of the present invention, the image recognition model can be trained by deep learning image recognition technology, such as deep learning technology based on region proposals (Region-based Convolutional Neural Network (R-CNN), Region-based Fully Convolutional Neural Network (R-FCN)) or deep learning technology based on recursion (You Only Look Once (YOLO), a Single Shot Multibox Detector (SSD)). The present invention mainly uses YOLOv4-Tiny in the You Only Look Once (YOLO) series as the image recognition model.

Training methods of the image recognition model is ordinary knowledge in the technical filed. In short, practitioners drive a vehicle on road and use a lens to record images along the way. A photographing direction of the lens is a traveling direction of the host vehicle to collect images of the front of the host vehicle. The practitioners can use a computer to read each frame of the images of the front of the host vehicle captured by the lens, and perform image pre-processing (such as using Open CV) on each frame of the images of the front of the host vehicle. Then, the practitioners can use the processed images as a plurality of training images for training of the image recognition model. In an embodiment of the present invention, the plurality of training images is stored in an image database 11 of the storage unit 10. The computing unit 30 trains the image recognition model through the plurality of training images stored in the image database 11, wherein each of the plurality of training images contains at least one training vehicle.

YOLOv4-Tiny serves as the image recognition model and is a supervised learning model, so that the image recognition model can be trained through a plurality of training features V. For example, practitioners set a vehicle body center and a vehicle head center of the training vehicle as the plurality of training features V for the image recognition model to learn. Wherein, the plurality of training features V can be directly stored in the image recognition model. Furthermore, in an embodiment of the present invention, the plurality of training features V is stored in a vehicle type database 12 of the storage unit 10, and the computing unit 30 uses the plurality of training features V in the vehicle type database 12 to train the image recognition model. After repeated training of the image recognition model, when at least one target vehicle appears in an image, the vehicle body center and the vehicle head center of the at least one target vehicle can be recognized through YOLOv4-Tiny.

The photographing unit 20 is mounted on the motorcycle. A photographing direction of the photographing unit 20 is a traveling direction of the motorcycle, so as to capture the front image of the motorcycle and correspondingly output a real-time image I. For example, the photographing unit can be a visible light vehicle camera or an infrared vehicle camera.

The computing unit 30 is a processor with a data computing function, and the computing unit 30 consecutively receives the real-time image I output by the photographing unit 20. As mentioned above, the computing unit 30 can execute the program data of the image recognition model and perform image pre-processing on the real-time image I, causing the image recognition model to identify a plurality of target features of a target vehicle in the real-time I. The computing unit 30 predicts a turning path information of the target vehicle according to the plurality of target features, and them computes a range of radius difference between inner wheels of the target vehicle based on the turning path information. A prediction method of the turning path information and a generation method of the range of radius difference between inner wheels of the target vehicle will be further described in detail later. Furthermore, the computing unit 30 stores the processed real-time image I into the image database 11 as a new frame of training image. In other words, the new frame of training image will become one of the plurality of training images stored in the image database 11, and the plurality of target features will also be stored in the vehicle type database 12 as the training feature V. In this way, the image recognition model is continuously trained to improve efficiency and accuracy of image recognition of the image recognition model.

The computing unit 30 generates a warning signal E according to the range of radius difference between inner wheels of the target vehicle. The warning unit 40 is mounted on the motorcycle and electrically connected with the computing 30. The warning unit 40 issues a warning according to the warning signal E sent by the computing unit 30. In an embodiment of the present invention, the warning unit 40 may be an indicator light. The indicator light is mounted on a dashboard of the motorcycle. The warning signal E is adapted to control an on-off state of the indicator light, and the on-off state reflects whether the motorcycle will enter the range of radius difference between inner wheels of the target vehicle. When the motorcycle will enter the range of radius difference between inner wheels of the target vehicle, the indicator light will turn on. When the motorcycle will not enter the range of radius difference between inner wheels of the target vehicle, the indicator light will turn off. Wherein, whether the motorcycle will enter the range of radius difference between inner wheels of the target vehicle will be further described in detail later. Furthermore, the warning unit 40 can also be a buzzer, which is activated or deactivated according to the warning signal E to remind a rider of the motorcycle whether to enter the range of radius difference between inner wheels of the target vehicle. When the motorcycle will enter the range of radius difference between inner wheels of the target vehicle, the buzzer will be activated. When the motorcycle will not enter the range of radius difference between inner wheels of the target vehicle, the buzzer will be deactivated.

Furthermore, in an embodiment of the present invention, the warning unit 40 can also be a laser head device. The laser head device is mounted on the vehicle head of the motorcycle. The laser head device is controlled to project a laser light range on the road in front of the motorcycle through the warning signal E. The laser light range reflects the range of radius difference between inner wheels of the target vehicle, and reminds the rider of the motorcycle of the range of radius difference between inner wheels of the target vehicle.

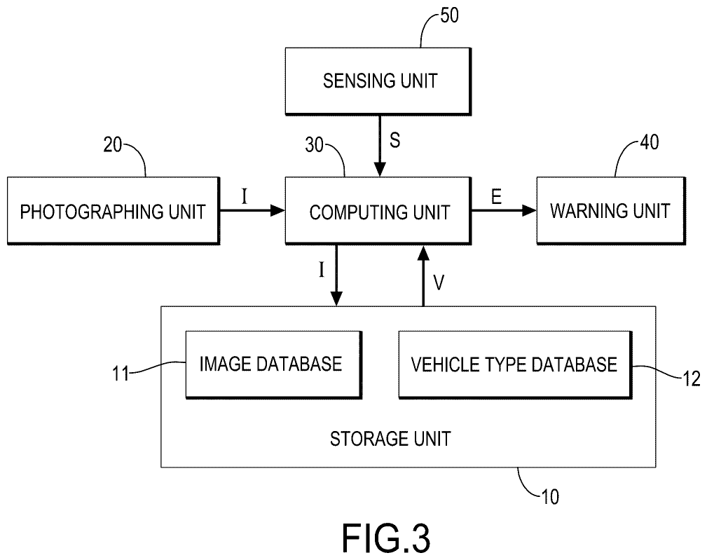

Preferably, referring to FIG. 3, the system further comprises a sensing unit in an embodiment of the present invention. The sensing unit 50 is mounted on the motorcycle and electrically connected with the computing unit 30. The sensing unit 50 is adapted to sense a traveling situation of the motorcycle to generate a vehicle information S and send the vehicle information S to the computing unit 30. For example, the sensing unit 50 may be a sensor module that integrates functions of a three-axis acceleration sensor and a gyroscope. The computing unit 30 combines the vehicle information S transmitted by the sensing unit 50 as a basis for determining whether the motorcycle will enter the range of radius difference between inner wheels of the target vehicle, wherein the vehicle information S may be such as at least one of speed information of the motorcycle and vehicle body inclination information.

Regarding whether the motor will enter the range of radius difference between inner wheels of the target vehicle, how to obtain an actual distance between the motorcycle and the target vehicle is first described. The actual distance between the motorcycle and the target vehicle can be obtained through one of the two embodiments described below.

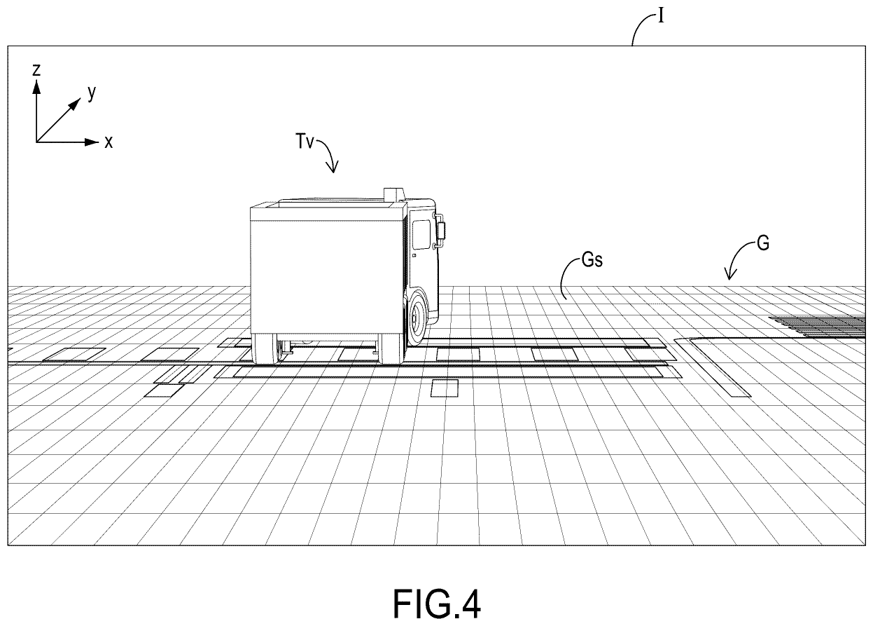

In one of the two embodiments to obtain the actual distance, referring to FIG. 4, the computing unit 30 can combine the real-time image I with a grid image G. Taking a three-axis coordinate direction in the figure as an example, the grid image G is an image scale in the XY plane. The grid image G includes a plurality of array grids Gs. The computing unit 30 estimates the actual distance between the motorcycle and the target vehicle according to the plurality of array grids Gs. For example, as shown in FIG. 4, a lower edge of the real-time image I is a position of the motorcycle, then the motorcycle and the target vehicle Tv are separated by 7 array grids Gs. An actual length corresponding to the length and width of each array grid Gs is 10 (unit: meters), so that the actual distance between the motorcycle and the target vehicle is 70 meters. Matters needing attention: the length and width of each array grid Gs in the grid image G should be consistent. The inconsistent length and width of each array grid Gs in FIG. 4 are due to a photographing angle of the real-time image I. Furthermore, the computing unit 30 can adjust the actual length corresponding to each array grid Gs according to the inclination of the motorcycle body.

In the other of the two embodiments to obtain the actual distance, the sensing unit 50 further comprises a distance measuring sensor. The distance measuring sensor is mounted on the motorcycle for detecting the distance between a target vehicle in front of the motorcycle and the motorcycle to generate a distance signal. The computing unit 30 receives and reads the distance signal to obtain the actual distance between the motorcycle and the target vehicle.

The computing unit 30 can determine whether the motorcycle will enter the range of radius difference between inner wheels of the target vehicle according to the actual distance between the motorcycle and the target vehicle and the speed information of the motorcycle. Assuming that the speed information of the motorcycle multiplied by a preset time is greater than the actual distance between the motorcycle and the target vehicle, the computing unit 30 determines that the motorcycle will enter the range of radius difference between inner wheels of the target vehicle. For example, as above mentioned, the actual distance between the motorcycle and the target vehicle is 70 meters, assuming that the speed information of the motorcycle is 60 kilometers/hour (when the unit is meter/second, the speed information of the motorcycle is 16.67 meters/second.), the preset time is 1.2 second. A product of the speed information of the motorcycle and the preset time is less than the actual distance between the motorcycle and the target vehicle (70 meters), so that the motorcycle will not enter the range of radius difference between inner wheels of the target vehicle.

To elaborate specifically on the operation methods of the prewarning system for blind spots of a front vehicle of the present invention, the following description will be made by taking the motorcycle mounted with the system and actually driven on the road as an example.

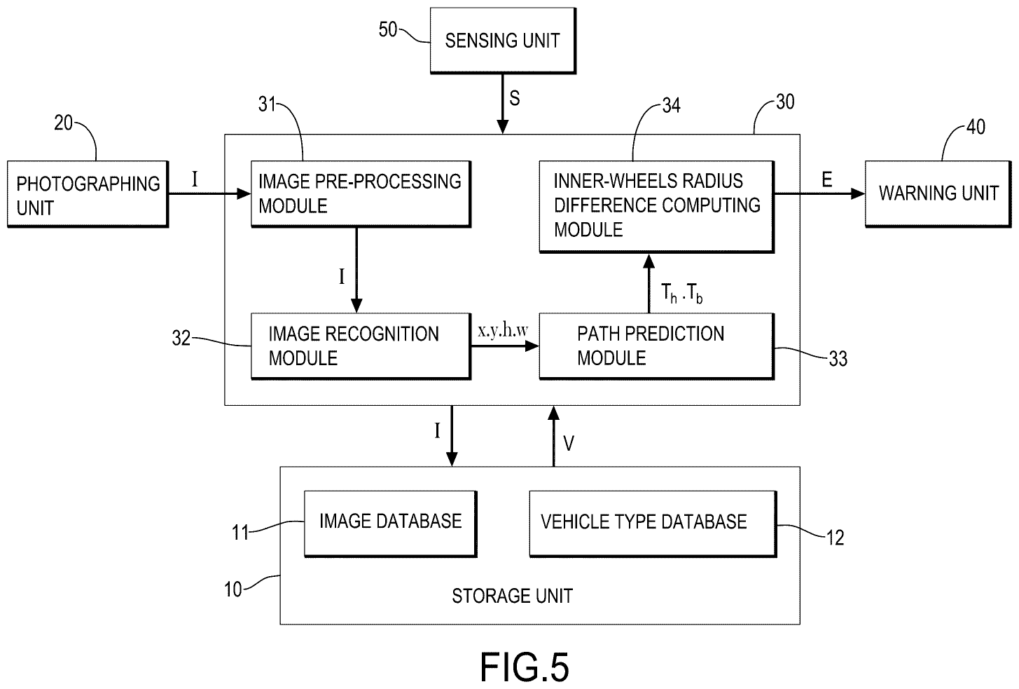

Referring to FIG. 5, the computing unit 30 further comprises an image pre-processing module 31, an image recognition module 32, a path prediction module 33 and an inner-wheels radius difference computing module 34. When the motorcycle is driven on the road, the photographing unit 20 transmits the real-time image I to the computing unit 30 every preset time (such as every one second). Because the motorcycle body may tilt, the real-time image I may be distorted or rotated. The image pre-processing module 31 mainly performs image pre-processing for the distortion or rotation of the real-time image I.

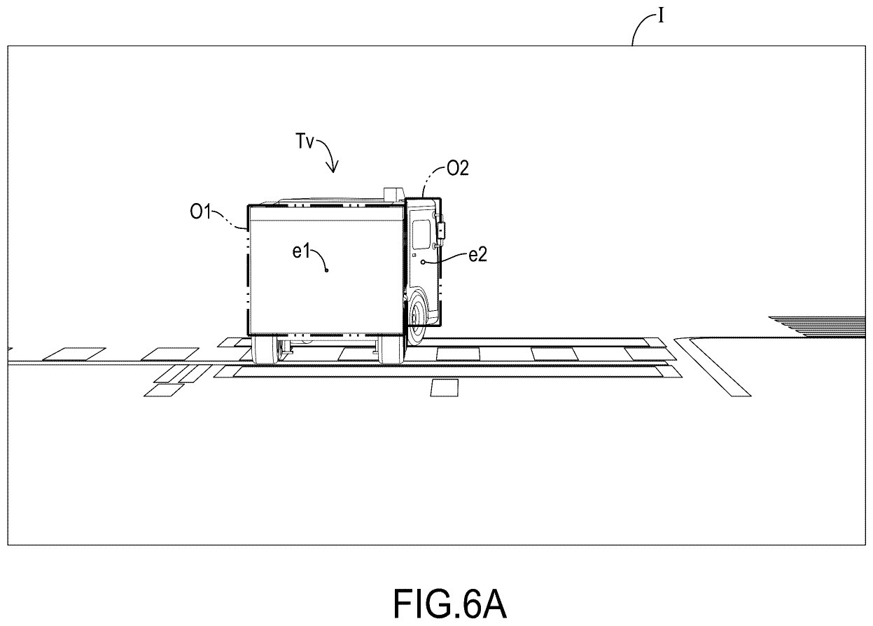

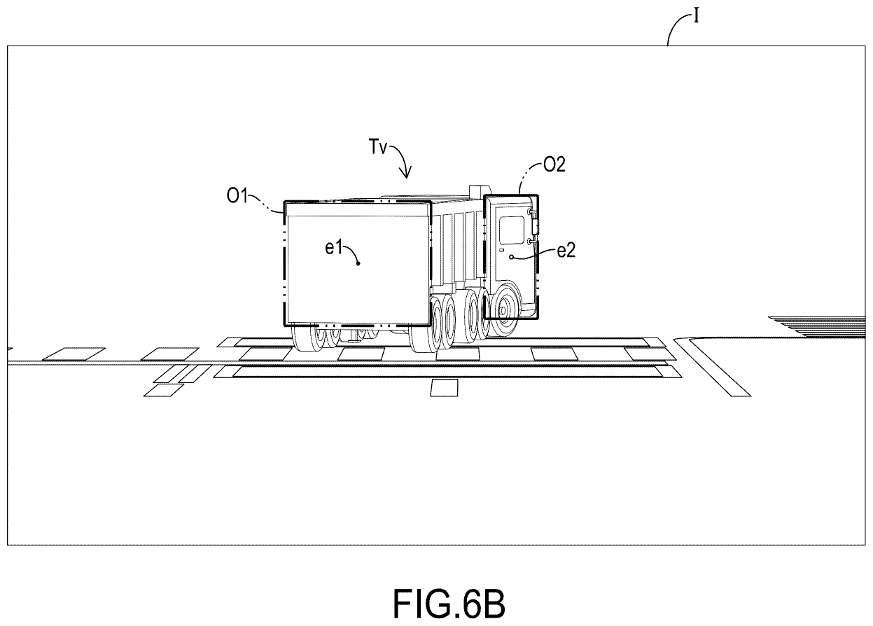

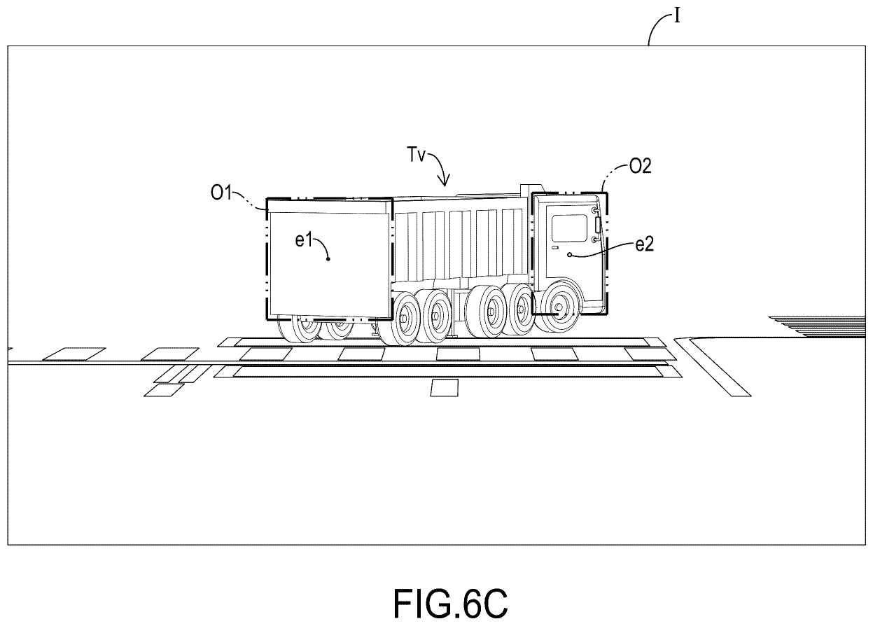

The image recognition module 32 receives the real-time image I that has completed image pre-processing. For example, the image recognition module 32 receives the real-time image I every second. Referring to FIGS. 6A to 6C, each real-time image I contains the target vehicle Tv. The image recognition module 32 is a module that executes the image recognition model of YOLOv4-Tiny as mentioned above. The image recognition module 32 can perform a vehicle recognition on the target vehicle Tv to generate at least one object frame, and the content in the at least one object frame is an object recognized by the image recognition module 32. As shown in FIGS. 6A to 6C, the object frames O1 and O2 respectively frame a vehicle body and a vehicle head of the target vehicle Tv. The image recognition module 32 recognizes two target features e1 and e2 from the object frame O1 and O2 respectively. Wherein, the two features e1 and e2 respectively correspond to a center point of the object frame O1 and the center point of the object frame O2, and positions of the target features e1 and e2 can respectively represent a vehicle body center and a vehicle head center of the target vehicle Tv.

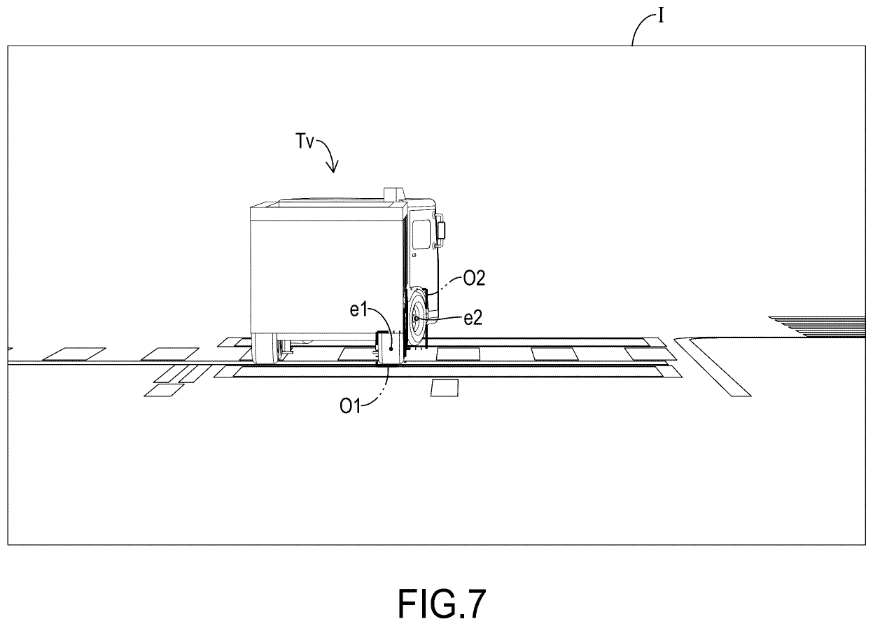

Please note that the figures only schematically depict that the image recognition module 32 can recognize two target features e1 and e2 to facilitate descriptions. However, if the image recognition model is provided with more training features for training, the image recognition model will be able to recognize more feature points of the target vehicle Tv. For example, as shown in FIG. 7, the object frames O1 and O2 can also respectively frame an inner back wheel and an inner front wheel of the target vehicle Tv when turning, and the target features e1 and e2 respectively represent an inner back wheel center and an inner front wheel center.

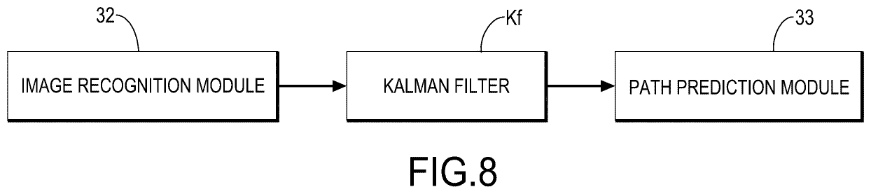

The image recognition module 32 computes a vehicle height h and a vehicle width w according to coordinates x and y of the target feature e1 and the coordinates x and y of the target feature e2, and the image recognition module 32 outputs information of the coordinates x and y of the target feature e1, the coordinates x and y of the target feature e2, the vehicle height h and the vehicle width w. Referring to FIG. 8, in an embodiment of the present invention, the image recognition module 32 is further connected with a Kalman filter Kf. The Kalman filter Kf is adapted to receive the output information of the image recognition module 32, such as information of the coordinates x and y of the target feature e1, the coordinates x and y of the target feature e2, the vehicle height h and the vehicle width w. The Kalman filter Kf generates an estimating data according to the output information of the image recognition module 32. The estimating data is used to improve a stability of image recognition of the coordinates x and y of the target feature e1 and the coordinates x and y of the target feature e2. Therefore, the Kalman filter Kf can preliminarily correct and output a motion path of the target vehicle Tv, and the motion path includes information of the coordinates x and y of the target feature e1, the coordinates x and y of the target feature e2, the vehicle height h and the vehicle width w.

The path prediction module 33 receives information of the coordinates x and y of each target feature, the vehicle height h and the vehicle width w and predicts the turning path information of the target vehicle Tv according to the coordinates x and y of each target feature. For example, the path prediction module 33 predicts the turning path information through a Long Short-Term Memory (LSTM) model. The operation method of the Long Short-Term Memory model is ordinary knowledge in the technical field and will not be described in detail. The Long Short-Term Memory model outputs a sequence of data according to the coordinates x and y of each target feature. Values of the sequence of data may be (x1, y1, x2, y2, . . . xn, yn) to represent a consecutive path of the coordinates x and y of the target feature e1 and the coordinates x and y of the target feature e2 in a prediction time in the future. Preferably, in order to increase a predication accuracy of the consecutive path of the path prediction module 33 within the prediction time, the path prediction module 33 can combine vehicle information S transmitted by the sensing unit 50 to output more accurate sequence data.

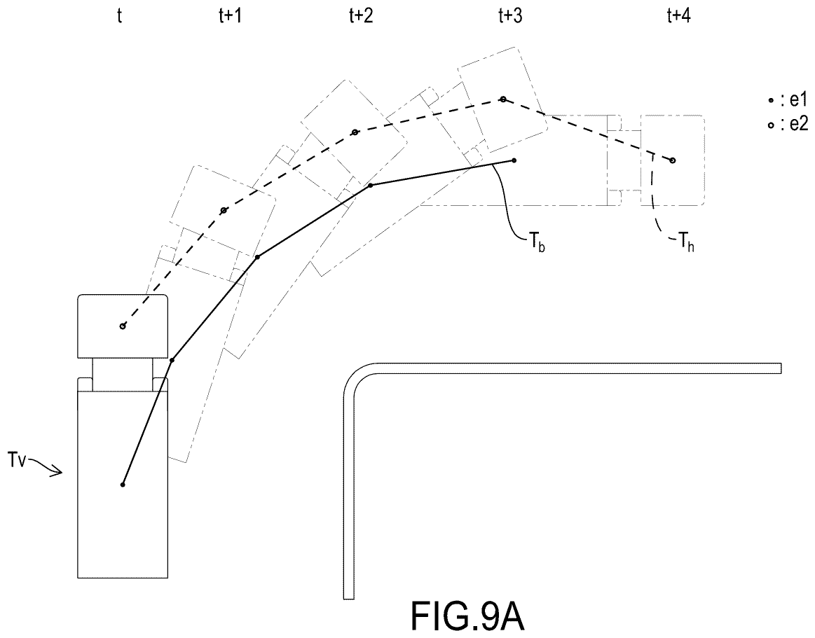

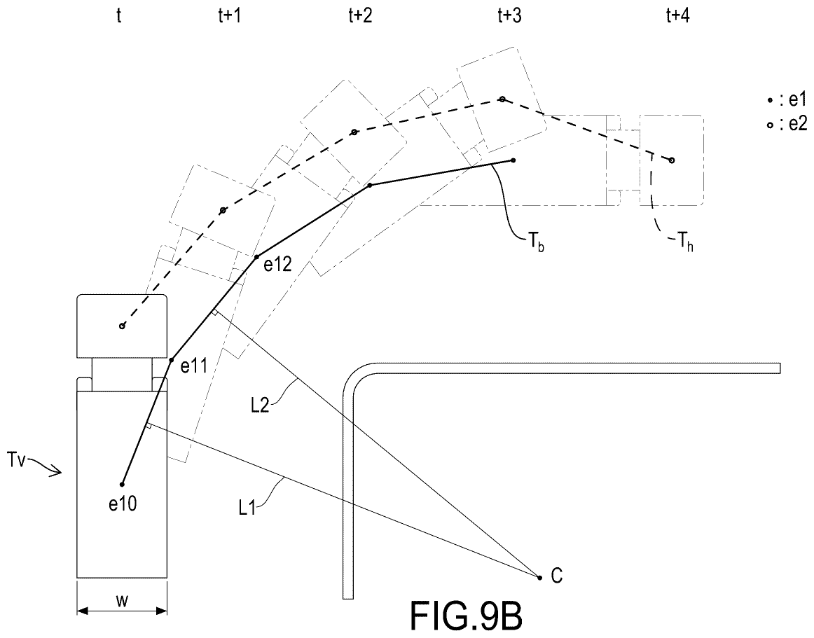

In an embodiment of the present invention, referring to FIG. 9A, the turning path information includes a body path T_{b} and a head path Tₕ. For example, the consecutive paths in the prediction in the future of the target features e1 and e2 predicted through the path prediction module 33 are shown in FIG. 9A. FIG. 9A only schematically depicts the target vehicle Tv at consecutive time points t to t+4, wherein time points t+1 to t+4 are in the prediction time in the future. A line connecting the target features e1 at each time point t to t+4 is the body path T_{b}, and the line connecting the target features e2 at each time point t to t+4 is the head path Tₕ. In another embodiment of the present invention, the two target features e1 and e2 recognized by the image recognition module 32 respectively represent the inner back wheel center and the inner front wheel center, and the turning path information includes an inner back wheel path T_{bW} and an inner front wheel path T_{fW}. The line connecting the inner back wheel center at multiple time points is the inner back wheel path T_{bW}, and the line connecting the inner front wheel center at multiple time points is the inner front wheel pat T_{fW}.

The inner-wheels radius difference computing module 34 receives the turning path information predicted by the path prediction module 33 and computes the range of the radius difference between inner wheels according to the turning path information. Then, the inner-wheels radius difference computing module 34 generates the warning signal E according to the range of the radius difference between inner wheels. In particular, there are two embodiments to compute the range of the radius difference between inner wheels by the inner-wheels radius difference computing module 34, which are described as follows.

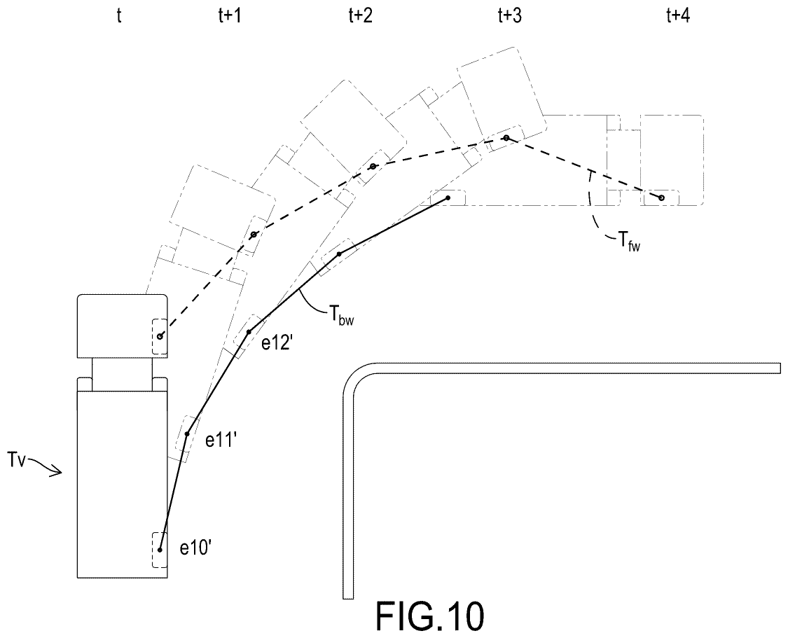

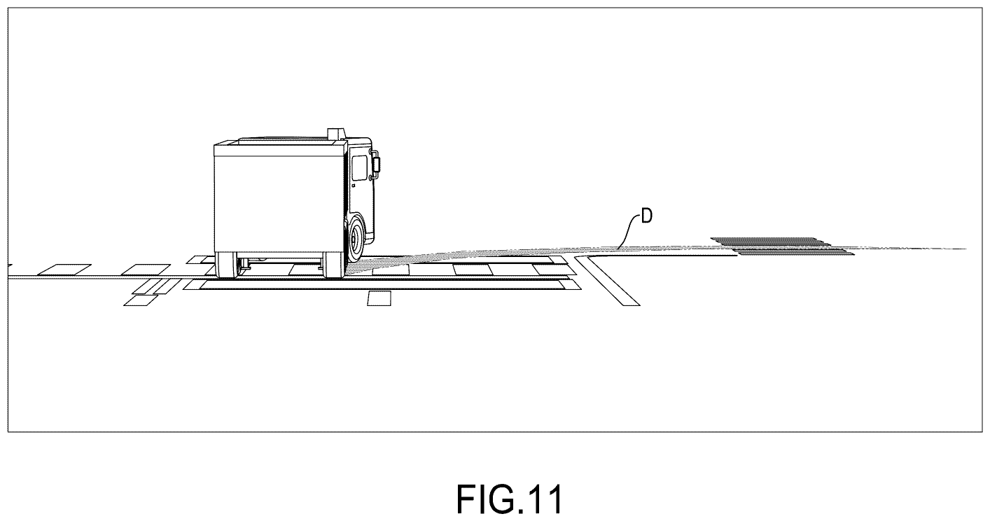

The first embodiment to compute the range of the radius difference between inner wheels: the inner-wheels radius difference computing module 34 receives the information of the body path T_{b} and the head path Tₕ as shown in the FIG. 9A, and the inner-wheels radius computing module 34 combines the information of the vehicle width w of the target vehicle Tv (as shown in FIG. 9B) to compute the inner front wheel path T_{fW} and the inner back wheel path T_{bW} of the target vehicle Tv when turning (as shown in FIG. 10).

For example, referring to FIG. 9B, the inner-wheels radius difference computing module 34 computes a perpendicular bisector L1 and a perpendicular bisector L2 according to any three consecutive body path points e10 to e12, wherein the body path points e10 to e12 are the vehicle body centers at three consecutive time points in the body path T_{b}. The perpendicular bisector L1 bisects the line connecting the two adjacent body path points e10 and e11 perpendicularly, and the perpendicular bisector L2 bisects the line connecting the two adjacent body path points e11 and e12 perpendicularly. The inner-wheels radius difference computing module 34 computes a position of a center C of a circle according to the two perpendicular bisectors L1 and L2. Referring to FIG. 10, the inner-wheels radius difference computing module 34 respectively obtains the coordinates of three inner back wheel path points e10′ to e12′ corresponding to the three body path points e10 to e12 according to the following two preset conditions:

The first preset condition: a slope of the line connecting between each body path point (e10 to e12) and the center C of the circle is same as a slope of the line connecting between each inner back wheel path point (e10′ to e12′) and the center C of the circle.

The second preset condition: the distance between each body path point (e10 to e12) and each inner back wheel path point (e10′ to e12′) is half of the vehicle width w.

The inner-wheels radius difference computing module 34 computes multiple inner back wheel path points of the target vehicle Tv according to the method mentioned above. Referring to FIG. 10, the line connecting the multiple inner back wheel path points at multiple time points is the inner back wheel path T_{bW} In the same way, the inner-wheels radius difference computing module 34 can compute other one circle center position according to multiple head path points and obtains inner front wheel path points of the target vehicle Tv according to the following two preset conditions:

The first preset condition: the slope of the line connecting between each head path point and the other circle center is same as the slope of the line connecting between each inner front wheel path point and the other circle center.

The second preset condition: a distance between each head path point and each inner front wheel path point is half of the vehicle width w.

Wherein, the line connecting the multiple inner front wheel path points at multiple time points is the inner front wheel path T_{fW}, and the range of radius difference between inner wheels D is the range enclosed by the inner front wheel path T_{fW} and the inner back wheel path T_{bW}.

The second embodiment to compute the range of the radius difference between inner wheels: referring to FIG. 10, the turning path information includes the inner front wheel path T_{fW} and the inner back wheel path T_{bW}. As mentioned above, the image recognition module 32 can recognize an inner back wheel center (e1) and an inner front wheel center (e2) of the target vehicle Tv as shown in FIG. 7. The image recognition module 32 forms the inner back wheel path T_{bW} by connecting multiple inner back wheel centers at multiple time points and forms the inner front wheel path T_{fW}. by connecting multiple inner front wheel centers at the multiple time points. The inner-wheels radius difference computing module 34 encloses the range of radius difference between inner wheels D according to the inner back wheel path T_{bW} and the inner front wheel path T_{fW}.

As mentioned above, the inner-wheels radius difference wheels computing module 34 can combine the vehicle information S transmitted by the sensing unit to determine whether the motorcycle will enter the range of radius difference between inner wheels D and generate the warning signal E according to a result of determination. The warning unit 40 receives the warning signal. For example, the warning unit 40 can be the indicator light or the buzzer. When the motorcycle enters the range of radius difference between inner wheels D, the warning signal E can be a first signal that enables the warning unit 40 to be turned on. When the motorcycle does not enter the range of radius difference between inner wheels D, the warning signal E can be a second signal that enables the warning unit 40 to be turned off. Alternatively, the warning unit 40 is an LED indicator light, the first signal can make the LED indicator light to emit red light, and the second signal can make the LED indicator light to emit green light.

When the warning unit 40 be the laser head device, the laser light range projected by the laser head device is the range of radius difference between inner wheels D. The computing unit 30 continuously computes the range of radius difference between inner wheels D, so that the laser light range continuously changes on the ground in front of the motorcycle with the changing range of radius difference between inner wheels D.

The prewarning system for blind spots of a front vehicle of the present invention continuously captures front images in the traveling direction of the user through a photographing unit, and the photographing unit outputs a real-time image. A computing unit continuously receives the real-time image and executes program data of an image recognition model. The computing unit recognizes a plurality of target features of a target vehicle in the real-time image through the image recognition model. The computing unit predicts a turning path information of the target vehicle and computes a range of radius difference between inner wheels according to the turning path information. The computing unit generates a warning signal according to the range of radius difference between inner wheels to control a warning unit. The warning unit can be an indicator light. When the computing unit determines that the user will enter the range of radius difference between inner wheels, the indicator light is turned on to remind the user to pay attention to a driving distance. Alternatively, the warning unit may be a laser head device, the laser head device projects a laser light range that reflects the range of radius difference between inner wheels on the road ahead according to the warning signal to remind the user to pay attention to the road conditions ahead. Thereby, the prewarning system for blind spots of a front vehicle of the present invention can achieve effects of assisting driving and improving a road safety of the user.

The above only records the implementations or embodiments of the technical artifices adopted by the present invention to solve the problems, and is not configured to limit the claims of the present invention. That is, all equivalent changes and modifications that are consistent with the meaning of the claims of the present invention or made in accordance with the claims of the present invention are covered by the claims of the present invention.

What is claimed is:

1. A prewarning system for blind spots of a front vehicle, comprising:
a photographing unit capturing a front image of a user to output a real-time image, wherein a photographing direction of the photographing unit is a traveling direction of the user;
a computing unit electrically connected with the photographing unit to receive the real-time image; the computing unit executing program data of an image recognition model to recognize a plurality of target features of a target vehicle in the real-time image; the computing unit predicting a turning path information of the target vehicle to compute a range of radius difference between inner wheels and generating a warning signal according to the range of radius difference between inner wheels; and
a warning unit electrically connected with the computing unit to receive the warning signal and outputting a warning according to the warning signal.

2. The prewarning system as claimed in claim 1, wherein the photographing unit, the computing unit, and the warning unit are mounted on a vehicle to be vehicle-mounted devices, and the plurality of target features are two target features; the two target features respectively represent a vehicle body center and a vehicle head center of the target vehicle, and the computing unit predicts the turning path information of the target vehicle according to the two target features.

3. The prewarning system as claimed in claim 2, wherein the computing unit receives the real-time image and performs image pre-processing for the real-time image.

4. The prewarning system as claimed in claim 2, wherein the computing unit receives the real-time image that has completed image pre-processing and executes program data of the image recognition model to recognize the plurality of target features through deep learning technology based on recursion.

5. The prewarning system as claimed in claim 2, wherein the computing unit predicts the turning path information through a Long Short-Term Memory model.

6. The prewarning system as claimed in claim 2, wherein the computing unit receives the turning path information which includes a body path and a head path to compute an inner back wheel path and an inner front wheel path of the target vehicle according to the body path, the head path, and information of a vehicle width of the target vehicle, wherein the range of radius difference between inner wheels is the range enclosed by the inner front wheel path and the inner back wheel path.

7. The prewarning system as claimed in claim 2, wherein the warning unit is an indicator light mounted on a dashboard of the vehicle; the warning signal is adapted to control an on-off state of the indicator light, and the on-off state reflects whether the vehicle is to enter the range of radius difference between inner wheels; when the vehicle enters the range of radius difference between inner wheels, the indicator light is turned on; when the vehicle does not enter the range of radius difference between inner wheels, the indicator light is turned off.

8. The prewarning system as claimed in claim 2, wherein the warning unit is a laser head device mounted on a vehicle head of the vehicle; the warning signal is adapted to control the laser head device to project a laser light range in front of the vehicle, wherein the laser light range reflects the range of radius difference between inner wheels.

9. The prewarning system as claimed in claim 1, wherein the photographing unit, the computing unit, and the warning unit are mounted on a vehicle to be vehicle-mounted devices, and the plurality of target features are two target features; the two target features respectively represent an inner back wheel center and an inner front wheel center of the target vehicle, and the computing unit predicts the turning path information of the target vehicle according to the two target features.

10. The prewarning system as claimed in claim 9, wherein the computing unit receives the real-time image and performs image pre-processing for the real-time image.

11. The prewarning system as claimed in claim 9, wherein the computing unit receives the real-time image that has completed image pre-processing and executes program data of the image recognition model to recognize the plurality of target features through deep learning technology based on recursion.

12. The prewarning system as claimed in claim 9, wherein the computing unit predicts the turning path information through a Long Short-Term Memory model.

13. The prewarning system as claimed in claim 9, wherein the computing unit receives the turning path information which includes an inner back wheel path and an inner front wheel path, wherein the range of radius difference between inner wheels is the range enclosed by the inner front wheel path and the inner back wheel path.

14. The prewarning system as claimed in claim 9, wherein the warning unit is an indicator light mounted on a dashboard of the vehicle; the warning signal is adapted to control an on-off state of the indicator light, and the on-off state reflects whether the vehicle is to enter the range of radius difference between inner wheels; when the vehicle enters the range of radius difference between inner wheel, the indicator light is turned on; when the vehicle does not enter the range of radius difference between inner wheels, the indicator light is turned off.

15. The prewarning system as claimed in claim 9, wherein the warning unit is a laser head device mounted on a vehicle head of the vehicle; the warning signal is adapted to control the laser head device to project a laser light range in front of the vehicle, wherein the laser light range reflects the range of radius difference between inner wheels.
